(19) United States
(12) Patent Application Publication
(10) Pub. No.: US 2026/0066975 A1
(43) Pub. Date: Mar. 5, 2026

(54) BEAM MONITORING BASED AT LEAST IN PART ON BEAM STATUS

(71) Applicant: Lenovo (United States) Inc., Morrisville, NC (US)

(72) Inventors: Ahmed Hindy, Aurora, IL (US); Sher Ali Cheema, Ilmenau (DE)

(73) Assignee: Lenovo (United States) Inc., Morrisville, NC (US)

(21) Appl. No.: 18/826,011

(22) Filed: Sep. 5, 2024

(51) Int. Cl. H04B 7/06; H04L 5/00; H04W 72/232; H04W 76/28

(52) U.S. Cl. CPC H04B 7/0691; H04L 5/0048; H04W 72/232; H04W 76/28

(57) ABSTRACT

Various aspects of the present disclosure relate to beam monitoring based at least in part on beam status. An apparatus, such as a user equipment (UE), receives a set of beams comprising a plurality of subsets of beams and receives an indication of an activation or deactivation of a first subset of beams of the plurality of subsets of beams. The UE can monitor the first subset of beams based at least in part on the indication.

### TECHNICAL FIELD

The present disclosure relates to wireless communications, and more specifically to beam management in non-terrestrial networks (NTN).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, configured to or operable to transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive (e.g., obtain, retrieve) a set of beams including a plurality of subsets of beams; receive an indication of an activation or deactivation of a first subset of beams of the plurality of subsets of beams; and monitor the first subset of beams based at least in part on the indication.

In some implementations of the method and apparatuses described herein, the set of beams is associated with a beam hopping framework, and the indication is received via a downlink control information (DCI); the indication is received via a DCI, and the DCI corresponds to a DCI format associated with one or more of a cell discontinuous transmission (DTX), cell discontinuous reception (DRX), or a conditional handover (CHO); the indication is received via a DCI, the DCI includes a plurality of information blocks, and each information block of the plurality of information blocks corresponds to a respective subset of beams of the plurality of subsets of beams; the at least one processor is configured to cause the UE to receive a higher-layer signal that identifies a location corresponding to a first bit of one or more information blocks of the plurality of information blocks included in the DCI that the UE is to monitor; each information block of the plurality of information blocks identifies whether beams in the first subset of beams are activated or deactivated; each beam in the set of beams corresponds to at least one of a non-zero power (NZP) channel state information reference signal (CSI-RS) or a synchronization signal block (SSB).

In some implementations of the method and apparatuses described herein, the at least one processor is configured to cause the UE to receive the at least one of the NZP CSI-RS or the SSB based at least in part on a cell DTX pattern, the cell DTX pattern includes alternating sequences of active slots and inactive slots, the active slots correspond to time slots in which the UE monitors for a reception of the at least one of the NZP CSI-RS or the SSB, and the inactive slots correspond to time slots in which the UE skips monitoring for the at least one of the NZP CSI-RS or SSB; a quantity of inactive slots associated with a first beam in the first subset of beams includes a period of active slots associated with a second beam in a second subset of beams; the first subset of beams and the second subset of beams are disjoint; the at least one processor is configured to cause the UE to further transmit a set of beams to a network entity, wherein each beam in the set of beams corresponds to a sounding reference signal (SRS) transmitted by the UE; the SRS is transmitted based at least in part on a cell DRX pattern, the cell DRX pattern includes alternating sequences of active slots and inactive slots, the active slots correspond to time slots in which the UE transmits the SRS, and the inactive slots correspond to time slots in which the UE suspends transmitting the SRS.

In some implementations of the method and apparatuses described herein, the indication is received via a DCI, and wherein the at least one processor is configured to cause the UE to transmit a channel state information (CSI) report or skips transmitting the CSI report based at least in part on information in the DCI; the at least one processor is configured to cause the UE to transmit the CSI report in response to receiving the indication within a threshold duration, wherein the indication identifies the activation of the first subset of beams in an information block; the set of beams is associated with a beam hopping framework that corresponds to the UE receiving the first subset of beams from the set of beams at a first time duration, and the UE receiving a second subset of beams from the set of beams at a second time duration, and wherein the first time duration and the second time duration are non-overlapping.

Some implementations of the method and apparatuses described herein may further include a processor for wireless communication to receive a set of beams including a plurality of subsets of beams; receive an indication of an activation or deactivation of a first subset of beams of the plurality of subsets of beams; and monitor the first subset of beams based at least in part on the indication.

Some implementations of the method and apparatuses described herein may further include a method performed by a UE, the method including receiving (e.g., obtaining, retrieving) a set of beams including a plurality of subsets of beams; receiving an indication of an activation or deactivation of a first subset of beams of the plurality of subsets of beams; and monitoring the first subset of beams based at least in part on the indication.

In some implementations of the method and apparatuses described herein, the method further comprising wherein the set of beams is associated with a beam hopping framework, and the indication is received via a DCI; wherein the indication is received via a DCI, and the DCI corresponds to a DCI format associated with one or more of a cell DTX, cell DRX, or a CHO; wherein the indication is received via a DCI, the DCI includes a plurality of information blocks, and each information block of the plurality of information blocks corresponds to a respective subset of beams of the plurality of subsets of beams; further including receiving a higher-layer signal that identifies a location corresponding to a first bit of one or more information blocks of the plurality of information blocks included in the DCI that the UE is to monitor; wherein each information block of the plurality of information blocks identifies whether beams in the first subset of beams are activated or deactivated; wherein each beam in the set of beams corresponds to at least one of a NZP CSI-RS or a SSB.

In some implementations of the method and apparatuses described herein, the method further comprising wherein the at least one processor is configured to cause the UE to receive the at least one of the NZP CSI-RS or the SSB based at least in part on a cell DTX pattern, the cell DTX pattern includes alternating sequences of active slots and inactive slots, the active slots correspond to time slots in which the UE monitors for a reception of the at least one of the NZP CSI-RS or the SSB, and the inactive slots correspond to time slots in which the UE skips monitoring for the at least one of the NZP CSI-RS or SSB; wherein a quantity of inactive slots associated with a first beam in the first subset of beams includes a period of active slots associated with a second beam in a second subset of beams; wherein the first subset of beams and the second subset of beams are disjoint; further including transmitting a set of beams to a network entity, wherein each beam in the set of beams corresponds to a SRS transmitted by the UE; wherein the SRS is transmitted based at least in part on a cell DRX pattern, the cell DRX pattern includes alternating sequences of active slots and inactive slots, the active slots correspond to time slots in which the UE transmits the SRS, and the inactive slots correspond to time slots in which the UE suspends transmitting the SRS.

In some implementations of the method and apparatuses described herein, the method further comprising wherein the indication is received via a DCI, and wherein the method further includes transmitting a CSI report or skips transmitting the CSI report based at least in part on information in the DCI; further including transmitting the CSI report in response to receiving the indication within a threshold duration, wherein the indication identifies the activation of the first subset of beams in an information block; wherein the set of beams is associated with a beam hopping framework that corresponds to the UE receiving the first subset of beams from the set of beams at a first time duration, and the UE receiving a second subset of beams from the set of beams at a second time duration, and wherein the first time duration and the second time duration are non-overlapping.

Some implementations of the method and apparatuses described herein may further include a NE for wireless communication to transmit (e.g., send, communicate) a set of beams including a plurality of subsets of beams; and transmit an indication of an activation or deactivation of a first subset of beams of the plurality of subsets of beams.

In some implementations of the method and apparatuses described herein, the set of beams is associated with a beam hopping framework, and the indication is transmitted via a DCI; the indication is transmitted via a DCI, and wherein a format of the DCI corresponds to a DCI format associated with one or more of a cell DTX, cell DRX, or a CHO.

Some implementations of the method and apparatuses described herein may further include a method performed by a NE, the method including transmitting (e.g., sending, communicating) a set of beams including a plurality of subsets of beams; and transmitting an indication of an activation or deactivation of a first subset of beams of the plurality of subsets of beams.

In some implementations of the method and apparatuses described herein, the method further comprising where the set of beams is associated with a beam hopping framework, and the indication is transmitted via a DCI; the indication is transmitted via a DCI, and wherein a format of the DCI corresponds to a DCI format associated with one or more of a cell DTX, cell DRX, or a CHO.

### BRIEF DESCRIPTION OF THE DRAWINGS

FIG. 1 illustrates an example of a wireless communications system in accordance with aspects of the present disclosure.

FIG. 2 illustrates aperiodic trigger state defining a list of CSI report settings.

FIG. 3 illustrates an aperiodic trigger state indicating the resource set and QCL information.

FIGS. 4a and 4b illustrate RRC configuration for NZP-CSI-RS/CSI-IM resources.

FIG. 5 illustrates partial CSI omission for Rel.

FIG. 6a and FIG. 6b illustrate different cell mapping scenarios in NTN.

FIG. 7 illustrates different scenarios for Frequency Reuse Factor (FRF).

FIG. 8 illustrates an example implementation scenario where multiple beams are in a cell and each beam is mapped to a BWP.

FIGS. 9-11 illustrate an example information element for DRX configuration.

FIG. 12 illustrates an example of a UE in accordance with aspects of the present disclosure.

FIG. 13 illustrates an example of a processor in accordance with aspects of the present disclosure.

FIG. 14 illustrates an example of a NE in accordance with aspects of the present disclosure.

FIG. 15 illustrates a flowchart of a method in accordance with aspects of the present disclosure.

FIG. 16 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Further, beams may be utilized to support wireless communication using time-frequency resources and beam management (e.g., beamforming) can assist in improving signal directivity to improve wireless coverage and capacity. In NTN deployments, satellites can be several hundred to several thousand kilometers away from ground UEs, and thus the role of beamforming can be crucial. For instance, a number of beams spanning a coverage area can be significantly larger than terrestrial network (TN) deployments, and thus power consumed on beam management and beam acquisition time can be significantly larger in NTN than in TN. Power consumption can become more critical as low-cost non-geostationary orbit (NGSO) satellites are power limited as compared to TN based stations. In such scenarios, distributing the limited satellite on-board power to a large number of beams can reduce the link budget significantly. Furthermore, for a NGSO system, a beam dwell time (e.g., the time over which the strongest beam per UE is expected to change) can be short which can result in the need of a beam update procedure.

Some scenarios for beam management utilize separate configuration and activation of a plurality of CSI Report settings and activation commands associated with beam management (e.g., beam measurement and reporting) corresponding to the plurality of beam groups. In such scenarios, however, the number of CSI report settings that can be activated simultaneously as well as the number of available CORESETs can be limited. Further, some scenarios propose a new signaling framework for beam hopping in NTN, including a new DCI format and new beam measurement framework. Supporting the new framework, however, can incur significant specification impact as well as additional complexity at the UE.

Aspects of the present disclosure are described in the context of a wireless communications system, and include implementations that provide an enhanced energy-efficient beam management framework for NTN deployments that at least partially utilizes current signaling mechanisms (e.g., current NR signaling mechanisms) for cell DTX. For instance, described solutions provide for grouping of a set of beams into a plurality of beam groups according to an activation behavior and/or deactivation behavior of a beam, where each beam in a same beam group can be characterized with at least one of a same activation behavior and/or deactivation behavior. Further, described solutions provide for reuse of DCI signaling dedicated for the activation and/or deactivation of at least one of cell DTX, cell DRX, and/or CHO to indicate a beam hopping pattern to a UE for downlink (DL) beam management targeting NTN deployments. Solutions further provide for enhanced CSI reporting frameworks that enable a UE to report CSI corresponding to a relevant beam group under NTN cell coverage.

By performing the described techniques, a device in a wireless communications system can increase signaling fidelity, decrease signaling overhead, and conserve power resources, such as in NTN communication scenarios.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. Aspects of the present disclosure are described in the context of a wireless communications system.

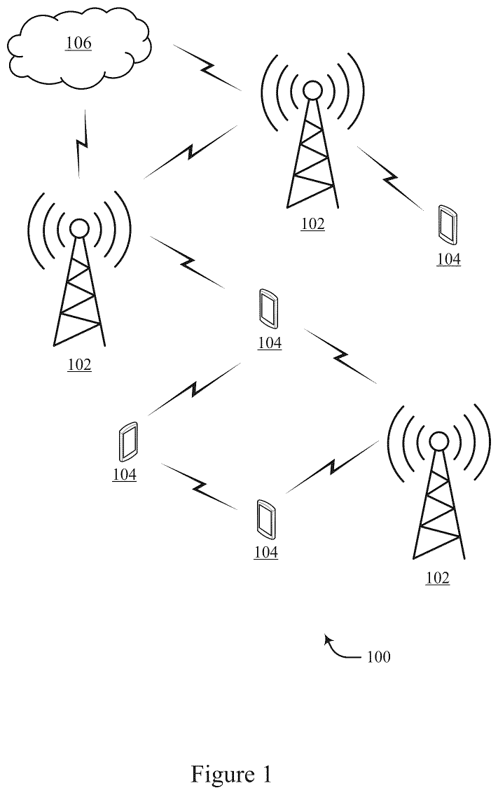

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FRI (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 can receive, from a NE 102, a set of beams including a plurality of subsets of beams and an indication of an activation or deactivation of a first subset of beams of the plurality of subsets of beams. The UE 104 can monitor the first subset of beams based at least in part on the indication. An NE 102 (e.g., a base station, gNB) can transmit, to the UE 104, a set of beams including a plurality of subsets of beams, and can transmit an indication of an activation or deactivation of a first subset of beams of the plurality of subsets of beams.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to CSI reporting, a codebook report can be partitioned into two parts based on the priority of information reported. Each part is encoded separately (Part 1 has a possibly higher code rate). Below we list the parameters for NR Rel. 16 Type-II codebook only.

For content of a CSI report:

Part 1: rank indicator (RI) + channel quality indicator (CQI) +
Total number of coefficients
Part 2: spatial domain (SD) basis indicator + frequency domain (FD) basis
indicator/layer + Bitmap/layer + Coefficient Amplitude info/layer +
Coefficient Phase info/layer + Strongest coefficient indicator/layer

Furthermore, Part 2 CSI can be decomposed into sub-parts each with different priority (higher priority information listed first). Such partitioning is required to allow dynamic reporting size for codebook based on available resources in the uplink phase.

Also Type-II codebook is based on aperiodic CSI reporting, and only reported in physical uplink shared channel (PUSCH) via DCI triggering (one exception). Type-I codebook can be based on periodic CSI reporting (physical uplink control channel (PUCCH)) or semi-persistent CSI reporting (PUSCH or PUCCH) or aperiodic reporting (PUSCH).

For priority reporting for CSI Part 2, note that multiple CSI reports may be transmitted with different priorities, as shown in Table 1 below. The priority of the N_{Rep} CSI reports are based on the following: 1. A CSI report corresponding to one CSI reporting setting for one cell may have higher priority compared with another CSI report corresponding to one other CSI reporting setting for the same cell; 2. CSI reports intended to one cell may have higher priority compared with other CSI reports intended to another cell; 3. CSI reports may have higher priority based on the CSI report content. For example, CSI reports carrying L1-reference signal received power (RSRP) information have higher priority; 4. CSI reports may have higher priority based on their type. For example, whether the CSI report is aperiodic, semi-persistent or periodic, and whether the report is sent via PUSCH or PUCCH, may impact the priority of the CSI report.

In light of these, CSI reports may be prioritized as follows, where CSI reports with lower IDs have higher priority

$${Pri}_{iCSI} ( y , k , c , s ) o = 2 \cdot {N}_{cells} \cdot {M}_{s} \cdot y + {N}_{cells} \cdot {M}_{s} \cdot k + {M}_{s} \cdot c + s$$

$$s : CSI reporting setting index , and$$

$${M}_{s} : Maximum number of CSI reporting settings$$

$$c : Cell index , and {N}_{cells} : Number of serving cells$$

$$k : 0 for CSI reports carrying L 1 - RSRP or$$

$$L 1 - Signal - to - Interference - and - Noise Ratio ( SIN R ) , 1 otherwise$$

$$y : 0 for aperiodic reports , 1 for semi - persistent reports on PUSCH ,$$

$$2 for semi - persistent reports on PUCCH , 3 for periodic reports .$$

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Por triggering aperiodic CSI reporting on PUSCH, a UE is to report the needed CSI information for the network using the CSI framework in NR Release 15. The triggering mechanism between a report setting and a resource setting can be summarized in Table 2 below.

TABLE 2
Triggering mechanism between a report
setting and a resource setting

| | | Periodic | | AP CSI |
|---|---|---|---|---|
| | | CSI | | Report- |
| | | reporting | SP CSI reporting | ing |
| Time Domain | Periodic | RRC | MAC CE (PUCCH) | DCI |
| Behavior of | CSI-RS | configured | DCI (PUSCH) | |
| Resource | SP CSI- | Not | MAC CE (PUCCH) | DCI |
| Setting | RS | Supported | DCI (PUSCH) | |
| | AP CSI- | Not | Not Supported | DCI |
| | RS | Supported | | |

Moreover: Associated Resource Settings for a CSI Report Setting may have a same time domain behavior; Periodic CSI-RS/interference management (IM) resource and CSI reports may be assumed to be present and active once configured by radio resource control (RRC); Aperiodic and semi-persistent CSI-RS/IM resources and CSI reports may be explicitly triggered or activated; For aperiodic CSI-RS/IM resources and aperiodic CSI reports, the triggering may be done jointly by transmitting a DCI Format 0-1; Semi-persistent CSI-RS/IM resources and semi-persistent CSI reports can be independently activated.

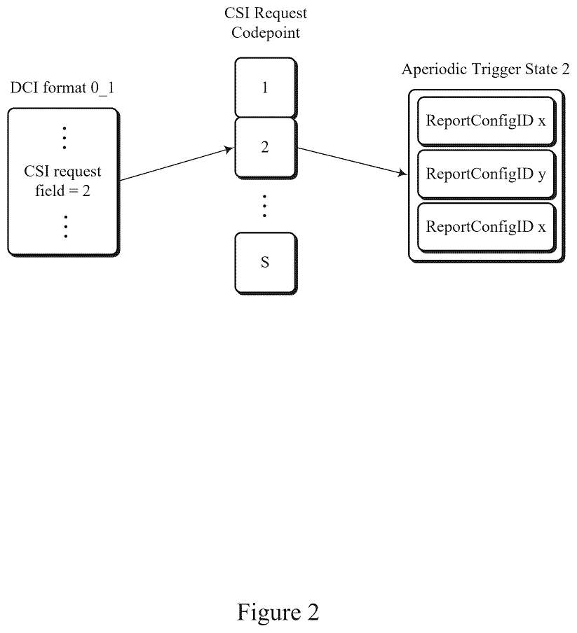

FIG. 2 illustrates aperiodic trigger state defining a list of CSI report settings. For aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC (see, e.g., FIG. 2). An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the quasi co-location (QCL) source to use is also configured in the aperiodic trigger state. The UE assumes that the resources used for the computation of the channel and interference can be processed with the same spatial filter, e.g., quasi-co-located with respect to “QCL-TypeD.”

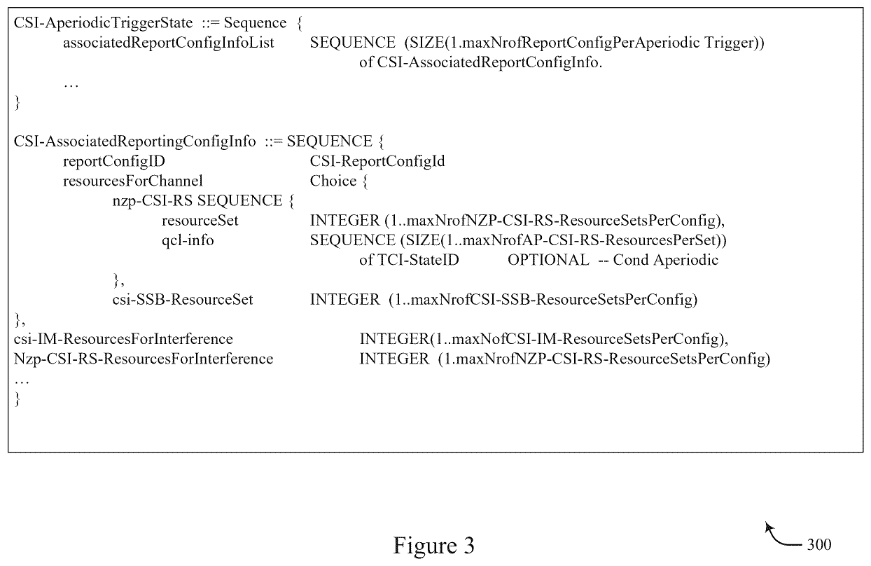

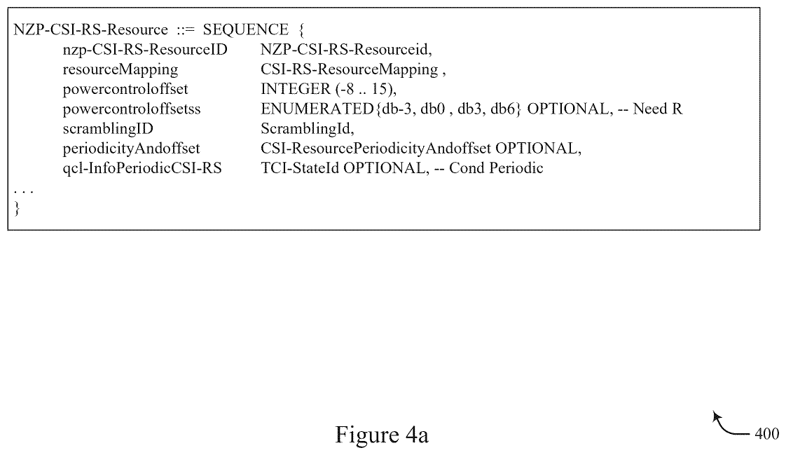

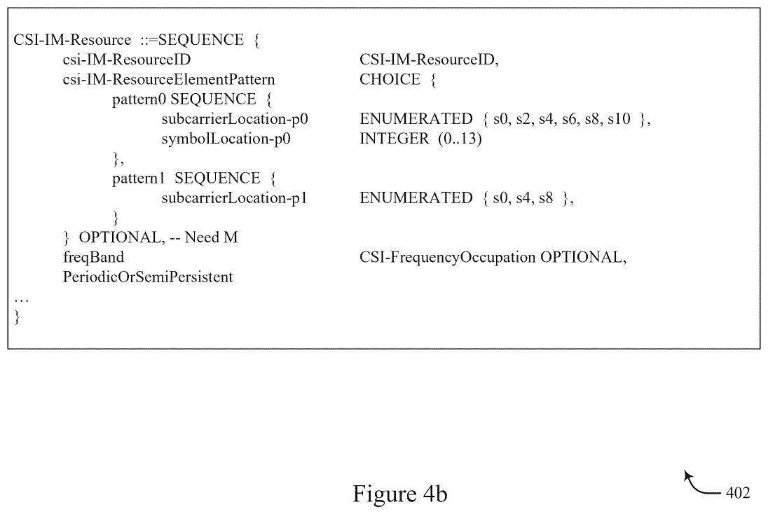

FIG. 3 illustrates at 300 aperiodic trigger state indicating the resource set and QCL information. FIGS. 4a and 4b illustrate RRC configuration for NZP-CSI-RS/CSI-IM resources. For instance, 400 illustrates RRC configuration for NZP-CSI-RS Resource and 402 illustrates RRC configuration for CSI-IM-Resource.

Table 3 below summarizes the type of uplink channels used for CSI reporting as a function of the CSI codebook type.

TABLE 3
Uplink channels used for CSI reporting
as a function of the CSI codebook type

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. CSI Part 1 can have a fixed payload size (and can be decoded by the gNB without prior information) and contains the following: RI (if reported), CSI-RS Resource Index (CRI) (if reported) and CQI for the first codeword; number of non-zero wideband amplitude coefficients per layer for Type II CSI feedback on PUSCH.

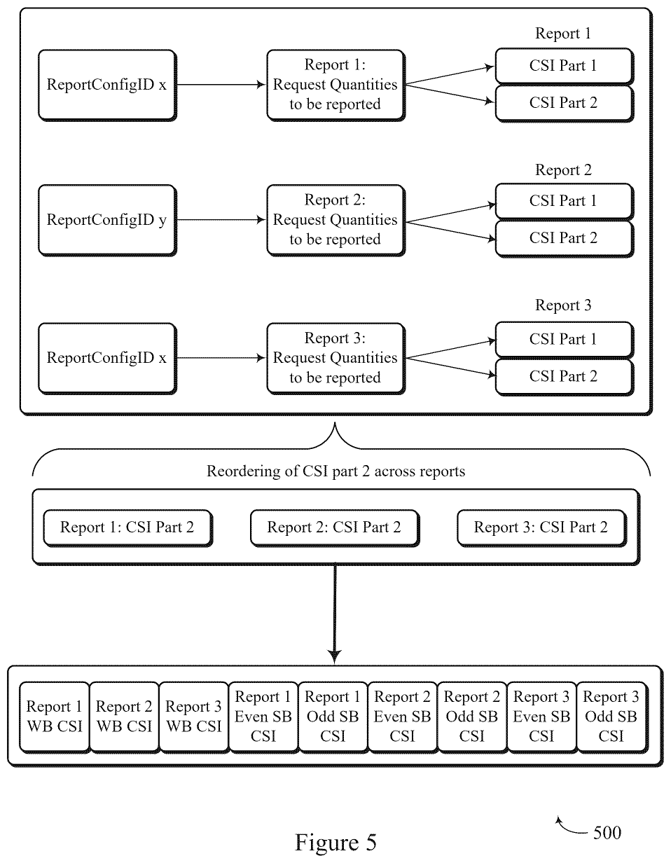

FIG. 5 illustrates at 500 partial CSI omission for Rel. 15 PUSCH-Based CSI. CSI Part 2 has a variable payload size that can be derived from the CSI parameters in CSI Part 1 and contains precoder matrix indicator (PMI) and the CQI for the second codeword when RI>4. For example, if the aperiodic trigger state indicated by DCI format 0_1 defines 3 report settings x, y, and z, then the aperiodic CSI reporting for CSI part 2 will be ordered as indicated at 500.

As mentioned earlier, CSI reports can be prioritized according to: Time-domain behavior and physical channel, where more dynamic reports are given precedence over less dynamic reports and PUSCH has precedence over PUCCH; CSI content, where beam reports (e.g., L1-RSRP reporting) has priority over regular CSI reports; The serving cell to which the CSI corresponds (in case of carrier aggregation (CA) operation). CSI corresponding to the PCell has priority over CSI corresponding to Scells; The reportConfigID.

In implementations powerControlOffset can be the assumed ratio of physical downlink shared channel (PDSCH) energy per resource element (EPRE) to NZP CSI-RS EPRE when UE derives CSI feedback and takes values in the range of [−8, 15] dB with 1 dB step size. For CQI calculation based on a pair of NZP CSI-RS resources, powerControlOffset of each NZP CSI-RS resource in the pair of NZP CSI-RS resources for channel measurement is the assumed ratio of EPRE when UE derives CSI feedback and takes values in the range of [−8, 15] dB with 1 dB step size. In implementations powerControlOffsetSS can be the assumed ratio of NZP CSI-RS EPRE to SS/physical broadcast channel (PBCH) block EPRE.

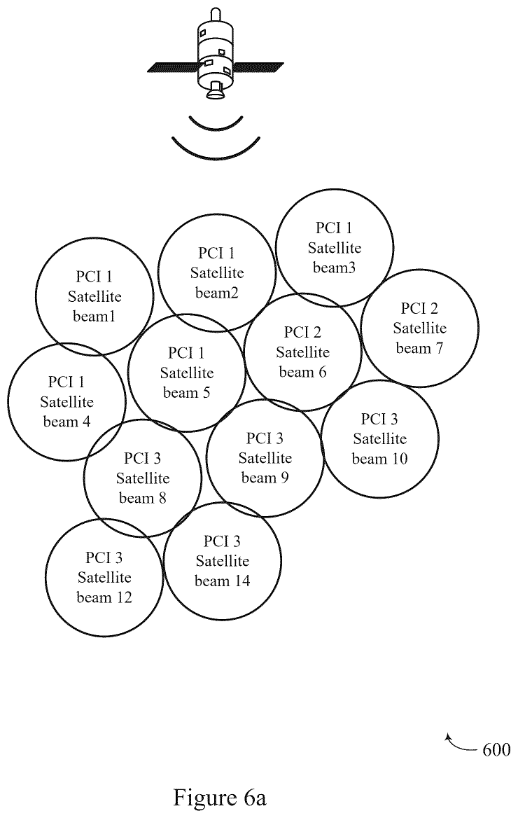

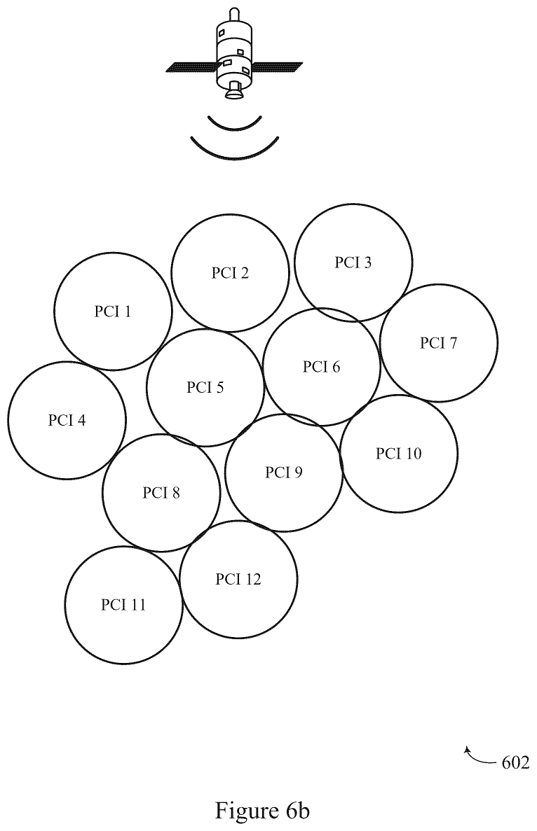

FIG. 6a and FIG. 6b illustrate different cell mapping scenarios in NTN. For instance, FIG. 6a illustrates a scenario 600 where several satellite beams are in the same cell (same Physical Cell Identity (PCI) for all beam). FIG. 6b illustrates a scenario 602 where each satellite beam is considered as a cell. A satellite beam, for instance, can consist of one or more SSB beams.

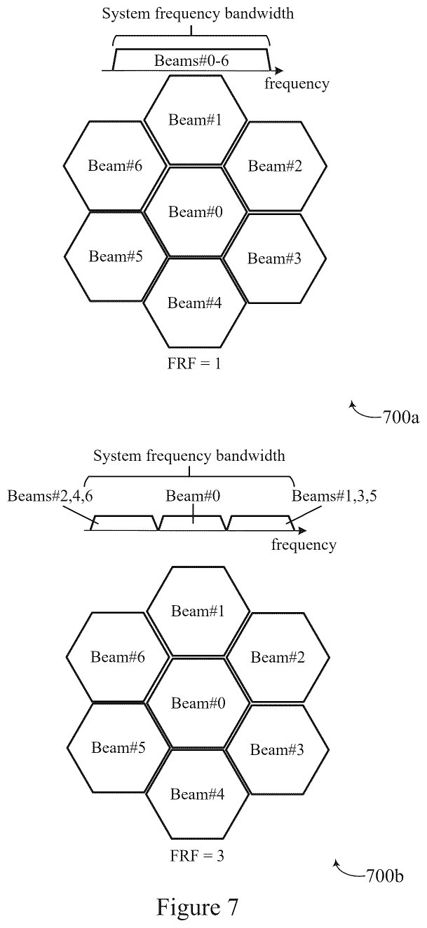

FIG. 7 illustrates different scenarios for Frequency Reuse Factor (FRF). For instance, a scenario 700a illustrates an example where FRF=1 and a scenario 700b illustrates an example where FRF=3. In NR NTN Frequency reuse schemes (FRF >1) have been proposed to mitigate inter-cell/beam co-channel interference. Spatial Frequency reuse techniques improve the SINR but can inherently limit the per-beam bandwidth and the system capacity. The traditional Frequency Reuse-3 (FRF-3, e.g., scenario 700b) scheme, for example, offers a protection against inter-cell interference. However, only a third of the spectral resources are used within each cell, as shown in the scenario 700b. NTN system level simulations have shown potential gains of FRF-3 scheme over FRF 1.

In scenarios of operation with one beam per cell, physical layer behavior can be straightforward although more higher layer procedures are required due to frequent handover especially for Low Earth Orbit (LEO). In scenarios of operation with multiple beams per cell, L1 beam management in Rel.15 can be reused frequently. In scenarios of frequency reuse larger than 1, the concept of using bandwidth parts (BWPs) to enable a frequency reuse was discussed during Release 16. It was proposed that mapping different BWPs to different parts of the system bandwidth and different beams would allow L1 based mobility within a large cell. Specifically, for a flexible Frequency Reuse, a beam-specific BWP can be configured. The objective is to replace the component carrier which is not as flexible as a BWP is. The same component carrier can be used on all cells (e.g., frequency reuse of 1), but each beam will be assigned a beam-specific BWP. For the configuration of beam specific BWPs in NTN, the same configuration parameters can be used: starting position, size and the subcarrier spacing. But in addition, an indication of the associated beam is to be added: a beam-index (CSI-RS associated with the beam).

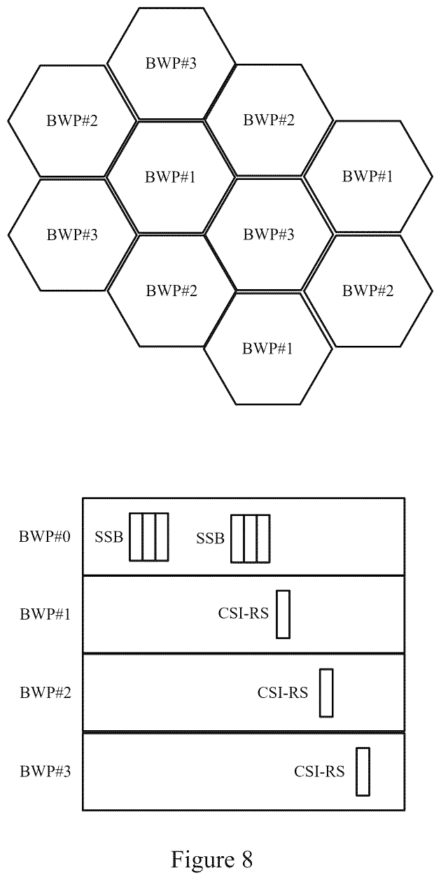

FIG. 8 illustrates an example implementation scenario where multiple beams are in a cell and each beam is mapped to a BWP. In legacy NR specifications, a device first needs to switch from initial BWP #0 to the serving BWP #x. Similarly in this case, SSBs via all beams within the cell are transmitted on BWP #0. The UE performs Downlink (DL) synchronization and Random Access Channel (RACH) procedure on BWP #0. After RRC connected, the BWP corresponding to the detected SSB can be configured to the UE as an active BWP (e.g., RRC-configured BWP). It requires that the satellite can transmit the SSB on BWP #0 in addition to transmit Physical Downlink Control Channel (PDCCH)/PDSCH on the associated BWP. In a word, BWP #0 can be used for initial cell access with all beams corresponding to SSB indices. For connected UE, an active BWP #1, #2, or #3 can be used with several beams. Assuming a device makes measurements on a BWP that is different from the BWP of the current serving satellite beam, the device will need to retune its carrier frequency for measurements and perform frequency compensation to report measurements frequently—e.g., every 10 seconds typically in LEO scenario with earth-moving beams.

For DRX, a medium access control (MAC) entity may be configured by RRC with a DRX functionality that controls the UE's PDCCH monitoring activity for the MAC entity's cell (C)-Radio Network Temporary Identifier (RNTI), cancellation indicator (CI)-RNTI, Common Search (CS)-RNTI, Interruption (INT)-RNTI, Slot Format Indicator (SFI)-RNTI, Semi-Persistent (SP)-CSI-RNTI, Transmit Power Control (TPC)-PUCCH-RNTI, TPC-PUSCH-RNTI, TPC-SRS-RNTI, Air Interface (AI)-RNTI, SL-RNTI, SL-CS-RNTI and Sidelink (SL) Semi-Persistent Scheduling V-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in 3GPP technical specification (TS) 38.213.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new uplink (UL), DL or SL transmission for the MAC entity;
drx-RetransmissionTimerDL (per DL hybrid automatic repeat request (HARQ) process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-NonIntegerLongCycleStartOffset (optional): the Long DRX cycle and drx-StartOffset which defines the subframe where the Long and Short DRX cycle start, when the length of the Long DRX cycle and/or the short DRX cycle is not an integer;
drx-ShortCycle (optional): the Short DRX cycle;
drx-NonIntegerShortCycle (optional): the Short DRX cycle whose length is not an integer;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per sidelink process): the maximum duration until a grant for SL retransmission is received;
drx-HARQ-RTT-TimerSL (per sidelink process): the minimum duration before an SL retransmission grant is expected by the MAC entity;
drx-LastTransmissionUL (optional): the configuration to start drx-HARQ-RTT-TimerUL after the last transmission within a bundle;
ps-Wakeup (optional): the configuration to start associated drx-onDurationTimer in case Downlink Control Information of Power Saving (DCP) is monitored but not detected;
ps-TransmitOtherPeriodicCSI (optional): the configuration to report periodic Channel State Information (CSI) that is not L1-Reference Signal Received Power (RSRP) on PUCCH during the time duration indicated by drx-onDurationTimer in case DCP is configured but associated drx-onDurationTimer is not started;
ps-TransmitPeriodicLI-RSRP (optional): the configuration to transmit periodic CSI that is L1-RSRP on PUCCH during the time duration indicated by drx-onDurationTimer in case DCP is configured but associated drx-onDurationTimer is not started;
DLHARQ-FeedbackDisabled (optional): the configuration to disable HARQ feedback per DL HARQ process;
uplinkHARQ-Mode (optional): the configuration to set HARQmodeA or HARQmodeB per UL HARQ process;
disableCG-RetransmissionMonitoring (optional): the configuration to disable starting drx-HARQ-RTT-TimerUL for UL transmission over a configured uplink grant;
drx-TimeReferenceSFN (optional): the reference System Frame Number (SFN) used in determining the start time of DRX on durations when short and/or long DRX cycle is not an integer.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-NonIntegerLongCycleStartOffset, drx-ShortCycle (optional), drx-NonIntegerShortCycle (optional), drx-ShortCycleTimer (optional), drx-HARQ-RTT-TimerDL, and drx-HARQ-RTT-TimerUL.

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer is running; or
a Scheduling Request is sent on PUCCH and is pending. If this Serving Cell is part of a non-terrestrial network, the Active Time is started after the Scheduling Request transmission that is performed when the SR_COUNTER is 0 for all the Scheduling Request (SR) configurations with pending SR(s) plus the UE-gNB Round Trip Time (RTT); or
a PDCCH indicating a new transmission addressed to the C-RNTI of the MAC entity has not been received after successful reception of a Random Access Response for the Random Access Preamble not selected by the MAC entity among the contention-based Random Access Preamble.

The following MAC timers can be used for DRX operation in a non-terrestrial network:
HARQ-RTT-TimerDL-NTN (per DL HARQ process configured with HARQ feedback enabled): the minimum duration before a DL assignment for HARQ retransmission is expected by the MAC entity;
HARQ-RTT-TimerUL-NTN (per UL HARQ process configured with HARQModeA): the minimum duration before a UL HARQ retransmission grant is expected by the MAC entity.

When DRX is not configured and multicast DRX is configured for a G-RNTI or G-CS-RNTI, the MAC entity shall:
1> monitor the PDCCH as specified in TS 38.213;
1> if a MAC PDU is received in a configured DL assignment for unicast; or
1> if the PDCCH indicates a DL unicast transmission:
2> stop the drx-RetransmissionTimerDL-PTM for the corresponding HARQ process.

When DRX is configured, the MAC entity shall:

```
1> if a MAC PDU is received in a configured DL assignment for unicast:
  2> if this Serving Cell is configured with DLHARQ-FeedbackDisabled:
    3> if the corresponding HARQ process is configured with HARQ feedback enabled:
      4> set HARQ-RTT-TimerDL-NTN for the corresponding HARQ process equal to drx-
        HARQ-RTT-TimerDL plus the latest available UE-gNB RTT value;
      4> start the HARQ-RTT-TimerDL-NTN for the corresponding HARQ process in the first
        symbol after the end of the corresponding transmission carrying the DL HARQ
        feedback.
  2> else:
    3> start the drx-HARQ-RTT-TimerDL for the corresponding HARQ process in the first
      symbol after the end of the corresponding transmission carrying the DL HARQ
      feedback.
NOTE 1a: Void.
NOTE 1b: Void.
  2> stop the drx-RetransmissionTimerDL for the corresponding HARQ process;
  2> stop the drx-RetransmissionTimerDL-PTM for the corresponding HARQ process.
1> if a MAC PDU is transmitted in a configured uplink grant and Listen Before Talk (LBT)
  failure indication is not received from lower layers:
  2> if this Serving Cell is configured with uplinkHARQ-Mode:
    3> if the corresponding HARQ process is configured as HARQModeA:
      4> set HARQ-RTT-TimerUL-NTN for the corresponding HARQ process equal to drx-
        HARQ-RTT-TimerUL plus the latest available UE-gNB RTT value;
      4> if drx-LastTransmissionUL is configured:
        5> start the HARQ-RTT-TimerUL-NTN for the corresponding HARQ process in the
          first symbol after the end of the last transmission (within a bundle) of the
          corresponding PUSCH transmission.
      4> else:
        5> start the HARQ-RTT-TimerUL-NTN for the corresponding HARQ process in the
          first symbol after the end of the first transmission (within a bundle) of the
          corresponding PUSCH transmission.
  2> else:
    3> if disableCG-RetransmissionMonitoring is not configured for the configured uplink
      grant:
      4> if drx-LastTransmissionUL is configured:
        5> start the drx-HARQ-RTT-TimerUL for the corresponding HARQ process in the
          first symbol after the end of the last transmission (within a bundle) of the
          corresponding PUSCH transmission.
      4> else:
        5> start the drx-HARQ-RTT-TimerUL for the corresponding HARQ process in the
          first symbol after the end of the first transmission (within a bundle) of the
          corresponding PUSCH transmission.
  2> stop the drx-RetransmissionTimerUL for the corresponding HARQ process at the first
    transmission (within a bundle) of the corresponding PUSCH transmission.
1> if a MAC PDU is transmitted in a configured sidelink grant:
  2> if the PUCCH resource is configured:
    3> start the drx-HARQ-RTT-TimerSL for the corresponding HARQ process in the first
      symbol after the end of the corresponding PUCCH transmission carrying the SL HARQ
      feedback; or
    3> start the drx-HARQ-RTT-TimerSZ for the corresponding HARQ process in the first
      symbol after the end of the corresponding PUCCH resource for the SL HARQ feedback
      when the PUCCH is not transmitted;
    3> stop the drx-RetransmissionTimerSZ for the corresponding HARQ process.
  2> else:
  3> start the drx-HARQ-RTT-TimerSL for the corresponding HARQ process at the first
      symbol after the end of the corresponding Physical Sidelink Shared Channel (PSSCH)
      transmission;
    3> stop the drx-RetransmissionTimerSL for the corresponding HARQ process.
1> if a drx-HARQ-RTT-TimerDL expires:
  2> if the data of the corresponding HARQ process was not successfully decoded:
    3> start the drx-RetransmissionTimerDL for the corresponding HARQ process in the first
        symbol after the expiry of drx-HARQ-RTT-TimerDL.
1> if a HARQ-RTT-TimerDL-NTN expires:
  2> if the data of the corresponding HARQ process was not successfully decoded:
    3> start the drx-RetransmissionTimerDL for the corresponding HARQ process in the first
      symbol after the expiry of HARQ-RTT-TimerDL-NTN.
1> if a drx-HARQ-RTT-TimerUL expires:
  2> start the drx-RetransmissionTimerUL for the corresponding HARQ process in the first
    symbol after the expiry of drx-HARQ-RTT-TimerUL.
1> if a HARQ-RTT-TimerUL-NTN expires:
  2> start the drx-RetransmissionTimerUL for the corresponding HARQ process in the first
    symbol after the expiry of HARQ-RTT-TimerUL-NTN.
1> if a drx-HARQ-RTT-TimerSL expires:
  2> if a HARQ Negative Acknowledgement (NACK) feedback for the corresponding HARQ
    process is transmitted on PUCCH; or
  2> if a HARQ NACK feedback for the corresponding HARQ process is generated but not
    transmitted on PUCCH; or
  2> if the PUCCH resource is not configured for the SL grant:
    3> start the drx-RetransmissionTimerSL for the corresponding HARQ process in the first
      symbol after the expiry of drx-HARQ-RTT-TimerSL.
NOTE : The UE handles the drx-RetransmissionTimerSL operation when sl-PUCCH-Config is
      configured by RRC but PUCCH resource is not scheduled same as when sl-PUCCH-
      Config is not configured.
1> if a DRX Command MAC control element (CE) indicated by PDCCH addressed to C-RNTI
  or CS-RNTI, or by a configured DL assignment for unicast transmission or a Long DRX
  Command MAC CE is received:
  2> stop drx-onDurationTimer for each DRX group;
  2> stop drx-InactivityTimer for each DRX group.
1> if drx-InactivityTimer for a DRX group expires:
  2> if the Short DRX cycle is configured:
    3> start or restart drx-ShortCycleTimer for this DRX group in the first symbol after the
      expiry of drx-InactivityTimer;
    3> use the Short DRX cycle for this DRX group.
  2> else:
    3> use the Long DRX cycle for this DRX group.
1> if a DRX Command MAC CE indicated by PDCCH addressed to C-RNTI or CS-RNTI, or by
  a configured DL assignment for unicast transmission is received:
  2> if the Short DRX cycle is configured:
    3> start or restart drx-ShortCycleTimer for each DRX group in the first symbol after the
      end of DRX Command MAC CE reception;
    3> use the Short DRX cycle for each DRX group.
  2> else:
    3> use the Long DRX cycle for each DRX group.
1> if drx-ShortCycleTimer for a DRX group expires:
  2> use the Long DRX cycle for this DRX group.
1> if a Long DRX Command MAC CE is received:
  2> stop drx-ShortCycleTimer for each DRX group;
  2> use the Long DRX cycle for each DRX group.
1> if the drx-NonIntegerLongCycleStartOffset is configured:
  2> increment DRX_SFN_COUNTER by 1 in the first symbol of a slot in which SFN changes
    to 0;
  2> if DRX is (re-)configured by RRC:
    3> set DRX_SFN_COUNTER to 0 in the first symbol of the slot immediately after the
      successful completion of the RRC (re-)configuration;
1> if the Short DRX cycle is used for a DRX group and the drx-NonIntegerShortCycle is not
  configured, and [(SFN × 10) + subframe number] modulo (drx-ShortCycle) = (drx-
  StartOffset) modulo (drx-ShortCycle); or
1> if the Short DRX cycle is used for a DRX group and the drx-NonIntegerShortCycle is
  configured, and floor([(DRX_SFN_COUNTER × 10240) + (SFN × 10) + subframe number]
  modulo (drx-NonIntegerShortCycle)) = floor([(drx-TimeReferenceSFN × 10) + drx-
  StartOffset] modulo (drx-NonIntegerShortCycle)):
  2> start drx-onDurationTimer for this DRX group after drx-SlotOffset from the beginning of
    the subframe.
1> if the Long DRX cycle is used for a DRX group and the drx-NonIntegerLongCycleStartOffset
  is not configured, and [(SFN × 10) + subframe number] modulo (drx-LongCycle) = drx-
  StartOffset; or
1> if the Long DRX cycle is used for a DRX group and the drx-NonIntegerLongCycleStartOffset
  is configured, and floor([(DRX_SFN_COUNTER × 10240) + (SFN × 10) + subframe number]
  modulo (drx-NonIntegerLongCycle)) = floor([(drx-TimeReferenceSFN × 10) + drx-
  StartOffset] modulo (drx-NonIntegerLongCycle)):
  2> if DCP monitoring is configured for the active DL BWP as specified in TS 38.213 [6],
    clause 10.3:
    3> if DCP indication associated with the current DRX cycle received from lower layer
      indicated to start drx-onDurationTimer, as specified in TS 38.213; or
    3> if all DCP occasion(s) in time domain, as specified in TS 38.213, associated with the
      current DRX cycle occurred in Active Time considering grants/assignments/DRX
      Command MAC CE/Long DRX Command MAC CE received and Scheduling Request
      sent until 4 ms prior to start of the last DCP occasion, or during a measurement gap, or
      when the MAC entity monitors for a PDCCH transmission on the search space indicated
      by recoverySearchSpaceld of the SpCell identified by the C-RNTI while the ra-
      ResponseWindow is running (as specified in clause 5.1.4); or
    3> if ps-Wakeup is configured with value true and DCP indication associated with the
      current DRX cycle has not been received from lower layers:
      4> start drx-onDurationTimer after drx-SlotOffset from the beginning of the subframe.
  2> else:
    3> start drx-onDurationTimer for this DRX group after drx-SlotOffset from the beginning
      of the subframe.
NOTE 2: In case of unaligned SFN across carriers in a cell group, the SFN of the SpCell is
      used to calculate the DRX duration.
1> if a DRX group is in Active Time:
  2> monitor the PDCCH on the Serving Cells in this DRX group as specified in TS 38.213 [6];
  2> if the PDCCH indicates a DL transmission; or
  2> if the PDCCH indicates a one-shot HARQ feedback as specified in clause 9.1.4 of TS
    38.213; or
  2> if the PDCCH indicates a retransmission of HARQ feedback as specified in clause 9.1.5 of
    TS 38.213:
    3> if this Serving Cell is configured with DLHARQ-FeedbackDisabled:
      4> if the corresponding HARQ process is configured with HARQ feedback enabled:
        5> set HARQ-RTT-TimerDL-NTN for the corresponding HARQ process equal to drx-
          HARQ-RTT-TimerDL plus the latest available UE-gNB RTT value;
        5> start the HARQ-RTT-TimerDL-NTN for the corresponding HARQ process in the
          first symbol after the end of the corresponding transmission carrying the DL
          HARQ feedback.
    3> else:
      4> start or restart the drx-HARQ-RTT-TimerDL for the corresponding HARQ
        process(es) whose HARQ feedback is reported in the first symbol after the end of the
        corresponding transmission carrying the DL HARQ feedback.
NOTE 3:
When HARQ feedback is postponed by PDSCH-to-HARQ_feedback timing
      indicating an inapplicable k1 value, as specified in TS 38.213, the corresponding
      transmission opportunity to send the DL HARQ feedback is indicated in a later PDCCH
      requesting the HARQ-Acknowledgement (ACK) feedback.
    3> stop the drx-RetransmissionTimerDL for the corresponding HARQ process(es) whose
      HARQ feedback is reported;
    3> stop the drx-RetransmissionTimerDL-PTM for the corresponding HARQ process;
    3> if the PDSCH-to-HARQ_feedback timing indicate an inapplicable k1 value as specified
      in TS 38.213:
      4> start the drx-RetransmissionTimerDL in the first symbol after the (end of the last)
        PDSCH transmission (within a bundle) for the corresponding HARQ process.
  2> if the PDCCH indicates a UL transmission:
    3> if this Serving Cell is configured with uplinkHARQ-Mode:
      4> if the corresponding HARQ process is configured as HARQModeA:
        5> set HARQ-RTT-TimerUL-NTN for the corresponding HARQ process equal to drx-
          HARQ-RTT-TimerUL plus the latest available UE-gNB RTT value;
        5> if drx-LastTransmissionUL is configured:
          6> start the HARQ-RTT-TimerUL-NTN for the corresponding HARQ process in
            the first symbol after the end of the last transmission (within a bundle) of the
            corresponding PUSCH transmission.
        5> else:
          6> start the HARQ-RTT-TimerUL-NTN for the corresponding HARQ process in
            the first symbol after the end of the first transmission (within a bundle) of the
            corresponding PUSCH transmission.
    3> else:
      4> if drx-LastTransmissionUL is configured:
        5> start the drx-HARQ-RTT-TimerUL for the corresponding HARQ process in the
          first symbol after the end of the last transmission (within a bundle) of the
          corresponding PUSCH transmission.
      4> else:
        5> start the drx-HARQ-RTT-TimerUL for the corresponding HARQ process in the
          first symbol after the end of the first transmission (within a bundle) of the
          corresponding PUSCH transmission.
    3> stop the drx-RetransmissionTimerUL for the corresponding HARQ process.
  2> if the PDCCH indicates an SL transmission:
    3> if the PUCCH resource is configured:
      4> start the drx-HARQ-RTT-TimerSZ for the corresponding HARQ process in the first
        symbol after the end of the corresponding PUCCH transmission carrying the SL
        HARQ feedback; or
      4> start the drx-HARQ-RTT-TimerSL for the corresponding HARQ process in the first
        symbol after the end of the corresponding PUCCH resource for the SL HARQ
        feedback when the PUCCH is not transmitted;
      4> stop the drx-RetransmissionTimerSL for the corresponding HARQ process.
    3> else:
      4> start the drx-HARQ-RTT-TimerSL for the corresponding HARQ process at the first
        symbol after end of PDCCH occasion;
      4> stop the drx-RetransmissionTimerSZ for the corresponding HARQ process.
  2> if the PDCCH indicates a new transmission (DL, UL or SL) on a Serving Cell in this DRX
    group:
    3> start or restart drx-InactivityTimer for this DRX group in the first symbol after the end
      of the PDCCH reception.
NOTE 3a: A PDCCH indicating activation of Semi-Persistent Scheduling (SPS), configured
      grant type 2, or configured sidelink grant of configured grant Type 2 is considered to
      indicate a new transmission.
NOTE 3b: If the PDCCH reception includes two PDCCH candidates from corresponding search
      spaces, as described in clause 10.1 in TS 38.213, start or restart drx-InactivityTimer for
      this DRX group in the first symbol after the end of the PDCCH candidate that ends later
      in time.
  2> if a HARQ process receives DL feedback information and acknowledgement is indicated:
    3> stop the drx-RetransmissionTimerUL for the corresponding HARQ process.
1> if DCP monitoring is configured for the active DL BWP as specified in TS 38.213, clause
  10.3; and
1> if the current symbol n occurs within drx-onDurationTimer duration; and
1> if drx-onDurationTimer associated with the current DRX cycle is not started as specified in
  this clause:
  2> if the MAC entity would not be in Active Time considering grants/assignments/DRX
    Command MAC CE/Long DRX Command MAC CE received and Scheduling Request
    sent until 4 ms prior to symbol n when evaluating all DRX Active Time conditions as
    specified in this clause; and
  2> if allowCSI-SRS-Tx-MulticastDRX-Active is not configured, or if cfr-ConfigMulticast is not
    configured for any of the active BWP(s) of the Serving Cell(s), or if all multicast DRXes
    would not be in Active Time considering multicast assignments/DRX Command MAC CE
    for Multicast Broadcast Service (MBS) multicast received until 4 ms prior to symbol n
    when evaluating all DRX Active Time conditions as specified in Clause 5.7b and all
    multicast sessions are configured with multicast DRX:
    3> not transmit periodic Sounding Reference Signal (SRS) and semi-persistent SRS
      defined in TS 38.214;
    3> not report semi-persistent CSI configured on PUSCH;
    3> not report semi-persistent CSI on PUCCH;
    3> if ps-TransmitPeriodicL1-RSRP is not configured with value true:
      4> not report periodic CSI that is L1-RSRP on PUCCH.
    3> if ps-TransmitOtherPeriodicCSI is not configured with value true:
      4> not report periodic CSI that is not L1-RSRP on PUCCH.
1> else:
  2> in current symbol n, if a DRX group would not be in Active Time considering
    grants/assignments scheduled on Serving Cell(s) in this DRX group and DRX Command
    MAC CE/Long DRX Command MAC CE received and Scheduling Request sent until 4
    ms prior to symbol n when evaluating all DRX Active Time conditions as specified in this
    clause; and
  2> if allowCSI-SRS-Tx-MulticastDRX-Active is not configured, or if cfr-ConfigMulticast is not
    configured for any of the active BWP(s) of the Serving Cell(s), or, in current symbol n, if
    all multicast DRXes corresponding to the DRX group would not be in Active Time
    considering multicast assignments/DRX Command MAC CE for MBS multicast received
    until 4 ms prior to symbol n when evaluating all DRX Active Time conditions as specified
    in Clause 5.7b and all multicast sessions corresponding to the DRX group are configured
    with multicast DRX:
    3> not transmit periodic SRS and semi-persistent SRS defined in TS 38.214 in this DRX
      group;
    3> not report CSI on PUCCH and semi-persistent CSI configured on PUSCH in this DRX
      group.
  2> if CSI masking (csi-Mask) is setup by upper layers:
    3> in current symbol n, if drx-onDurationTimer of a DRX group would not be running
      considering grants/assignments scheduled on Serving Cell(s) in this DRX group and
      DRX Command MAC CE/Long DRX Command MAC CE received until 4 ms prior to
      symbol n when evaluating all DRX Active Time conditions as specified in this clause;
      and
    3> if allowCSI-SRS-Tx-MulticastDRX-Active is not configured, or if cfr-ConfigMulticast is
      not configured for any of the active BWP(s) of the Serving Cell(s), or, in current symbol
      n, if drx-onDurationTimerPTM(s) of all multicast DRXes corresponding to the DRX
      group would not be running considering DRX Command MAC CE for MBS multicast
      received until 4 ms prior to symbol n when evaluating all DRX Active Time conditions
      as specified in Clause 5.7b and all multicast sessions corresponding to the DRX group
      are configured with multicast DRX:
      4> not report CSI on PUCCH in this DRX group.
NOTE 4: If a UE multiplexes a CSI configured on PUCCH with other overlapping uplink
      control information (UCI(s)) according to the procedure specified in TS 38.213 clause
      9.2.5 and this CSI multiplexed with other UCI(s) would be reported on a PUCCH
      resource either outside DRX Active Time of the DRX group in which this PUCCH is
      configured or outside the on-duration period of the DRX group in which this PUCCH is
      configured if CSI masking is setup by upper layers, it is up to UE implementation
      whether to report this CSI multiplexed with other UCI(s).
```

The MAC entity shall ensure no rounding error is generated when performing the modulus operation with drx-NonIntegerShortCycle or drx-NonIntegerLongCycle as the divisor.

Regardless of whether the MAC entity is monitoring PDCCH or not on the Serving Cells in a DRX group, the MAC entity transmits HARQ feedback, aperiodic CSI on PUSCH, and aperiodic SRS defined in TS 38.214 on the Serving Cells in the DRX group when such is expected. The MAC entity needs not to monitor the PDCCH if it is not a complete PDCCH occasion, e.g., the Active Time starts or ends in the middle of a PDCCH occasion.

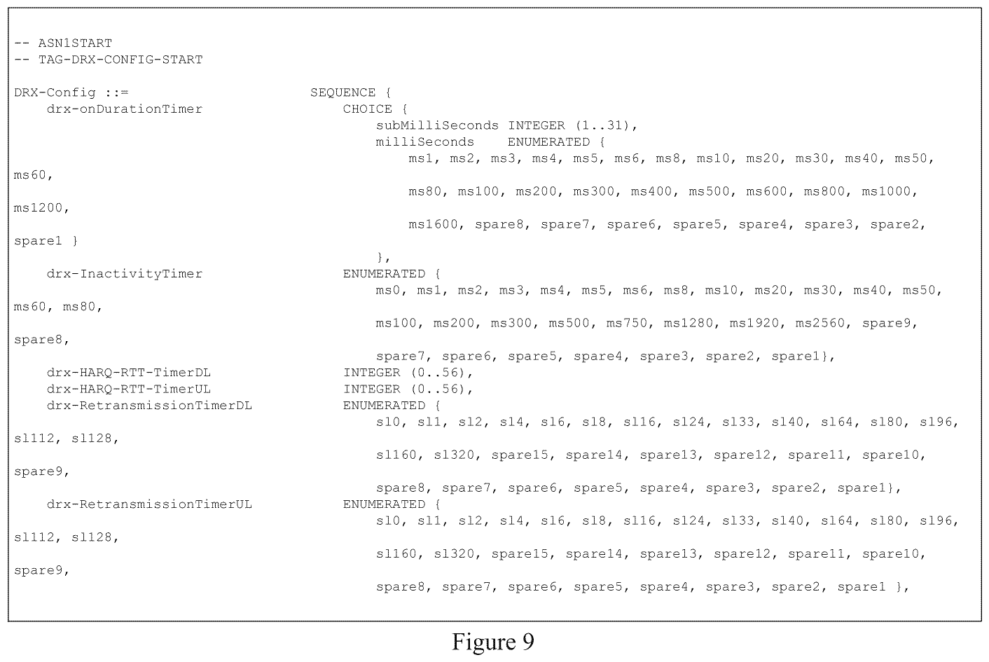

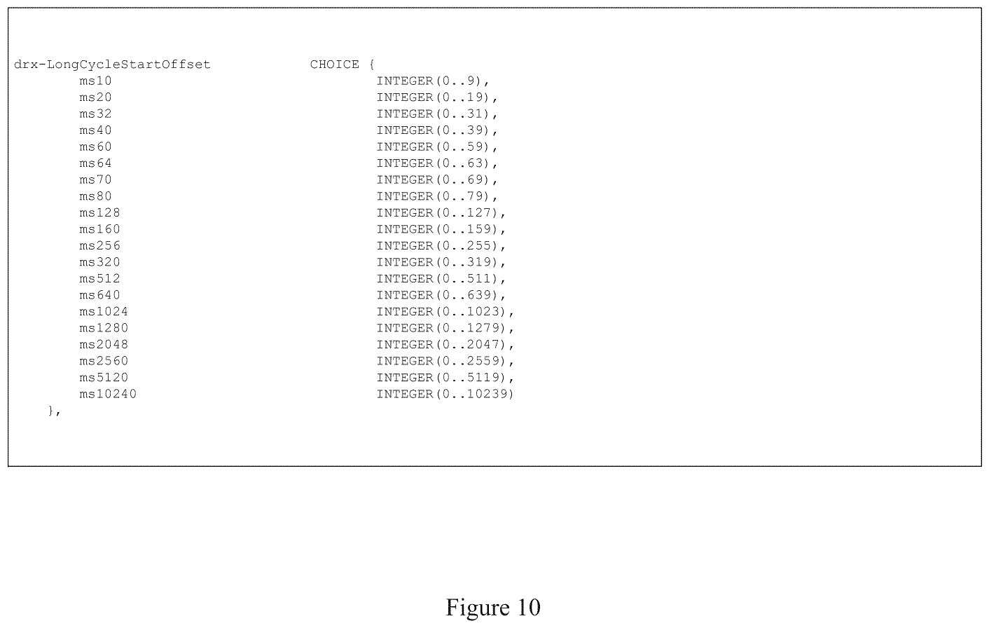

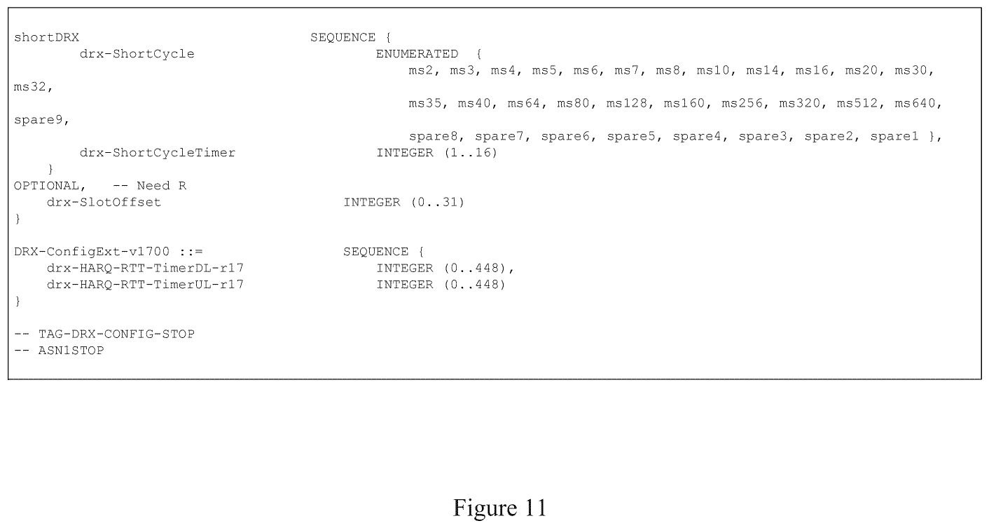

FIGS. 9-11 illustrate an example information element for DRX configuration. Table 4 below includes example descriptions of fields that can be included in the example information element for DRX configuration.

TABLE 4
DRX-Config IE field descriptions
DRX-Config field descriptions

drx-HARQ-RTT-TimerDL
Value in number of symbols of the BWP where the transport block was received. drx-HARQ-
RTT-TimerDL-r17 is only applicable for subcarrier spacing (SCS) 480 kHz and 960 kHz. If
configured, the UE shall ignore drx-HARQ-RTT-TimerDL (without suffix) for SCS 480 kHz and
960 kHz.
drx-HARQ-RTT-TimerUL
Value in number of symbols of the BWP where the transport block was transmitted. drx-HARQ-
RTT-TimerUL-r17 is only applicable for SCS 480 kHz and 960 kHz. If configured, the UE shall
ignore drx-HARQ-RTT-TimerUL (without suffix) for SCS 480 kHz and 960 kHz.
drx-InactivityTimer
Value in multiple integers of 1 ms. ms0 corresponds to 0, ms1 corresponds to 1 ms, ms2
corresponds to 2 ms, and so on.
drx-LongCycleStartOffset
drx-LongCycle in ms and drx-StartOffset in multiples of 1 ms. If drx-ShortCycle is configured,
the value of drx-LongCycle shall be a multiple of the drx-ShortCycle value.
drx-onDurationTimer
Value in multiples of 1/32 ms (subMilliSeconds) or in ms (milliSecond). For the latter, value ms1
corresponds to 1 ms, value ms2 corresponds to 2 ms, and so on.
drx-RetransmissionTimerDL
Value in number of slot lengths of the BWP where the transport block was received. value sl0
corresponds to 0 slots, sl1 corresponds to 1 slot, sl2 corresponds to 2 slots, and so on.
drx-RetransmissionTimerUL
Value in number of slot lengths of the BWP where the transport block was transmitted. sl0
corresponds to 0 slots, sl1 corresponds to 1 slot, sl2 corresponds to 2 slots, and so on.
drx-ShortCycleTimer
Value in multiples of drx-ShortCycle. A value of 1 corresponds to drx-ShortCycle, a value of 2
corresponds to 2 * drx-ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms, value 2
corresponds to 2/32 ms, and so on.

The following discusses antenna panel/port, quasi-collocation, Transmission Configuration Indication (TCI) state, and spatial relation. In some implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHZ, e.g., frequency range 2 (FR2) or millimeter wave (mmWave). In some implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels”. In one implementation, the device may support Uplink (UL) transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI state associated with a target transmission can indicate parameters for configuring a quasi-collocation relationship between the target transmission (e.g., target reference signal of Demodulation (DM)-RS ports of the target transmission during a transmission occasion) and a source reference signal(s) (e.g., SSB/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source reference signal to provide a reference (UE assumption) for determining QCL and/or spatial filter.

In some of the implementations described, a spatial relation information associated with a target transmission can indicate parameters for configuring a spatial setting between the target transmission and a reference signal (e.g., SSB/CSI-RS/SRS). For example, the device may transmit the target transmission with the same spatial domain filter used for reception the reference signal (e.g., DL reference signal such as SSB/CSI-RS). In another example, the device may transmit the target transmission with the same spatial domain transmission filter used for the transmission of the reference signal (e.g., UL reference signal such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference signal used for determining both the DL QCL information and the UL spatial transmission filter. The source reference signal determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the reference signal of DL QCL Type D in the joint TCI state. The spatial setting of the UL transmission may be according to the spatial relation with a reference to the source reference signal configured with qel-Type set to ‘typeD’ in the joint TCI state.

In the discussion herein: (1) the following notions can be used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a TCI state from a transmission configuration comprising at least two TCI states; (2) A Tracking Reference Signal (TRS) can correspond to an NZP CSI-RS resource set with a parameter ‘trs-info’ being configured; (3) A CSI-RS for beam management may correspond to CSI-RS associated with an NZP CSI-RS resource set with a parameter ‘repetition’ being configured; (4) A CSI-RS for CSI can correspond to an NZP CSI-RS resource set with neither parameters ‘trs-info’ nor ‘repetition’ being configured; (5) A matrix can imply a sequence of fields of an arbitrary dimension, including an array (vector) of values, a standard 2D matrix and more generally a Q-dimensional matrix (tensor) wherein Q≥2 is an integer value; (6) The notions CSI report setting, CSI report configuration, CSI reporting configuration can be used interchangeably to represent the same notion; (7) A CSI framework or procedure associated with up to 3GPP Rel-18 can be referred to as legacy behavior; (8) A beam may correspond to at least one of an NZP CSI-RS transmitted over a CSI-RS resource, or an SSB signal. Various implementations are described herein and one or more elements or features from one or more of the described implementations may be combined. Configuration and reporting aspects discussed herein may be applied for various NTN scenarios, e.g., when one beam corresponds to one cell or when multiple beams are configured within a cell. Configuration and reporting aspects discussed herein may be applied to various cell NTN cell layout configurations, e.g., earth-fixed cells, quasi earth-fixed cells, earth moving cells, etc.

Implementations provide for using a DCI format for cell DTX, cell DRX, and CHO for DL beam management indications in NTN deployments. In implementations, an indication can be provided (e.g., transmitted, communicated) to a UE indicating whether beam hopping is enabled or disabled. For instance, the UE can be configured with (e.g., receive, obtain) a parameter indicating that beam hopping is enabled or disabled, and the parameter may be part of higher layer RRC signaling and/or part of DCI configuration that is used to describe beam hopping parameters. Beam hopping, for example, corresponds to grouping of a set of beams that can switch on and off over a time duration in uplink or downlink where the configuration aspects of such grouping and related parameters can be set by the network and indicated to the network as part of cell DTX, cell DRX, and CHO configurations.

The indication of the beam hopping and/or beam management to the UE by the network may be implemented in various ways. For instance, the enabling/disabling of beam hopping may be part of DCI signaling used for cell DTX, cell DRX, and/or CHO configuration. In another implementation, a UE can receive (e.g., obtain) a separate indication for enabling/disabling of beam hopping using RRC signaling (e.g., as part of broadcast message using system information block (SIB) (for example in SIB 19 that is used for NTN parameters)), and the UE can receive beam hopping parameters as part of cell DTX, cell DRX, and/or CHO configurations. For instance, a new RRC indication signal can identify that DCI format 2_9 is associated with NTN beam hopping. In one example, a new RNTI (e.g., configured by higher layer) may be associated with NTN beam hopping, and the scrambling of the RNTI with either of cell DTX, cell DRX, and/or CHO configurations can provide the parameters associated with cell DTX, cell DRX, and/or CHO configurations may be used for NTN beam hopping.

In at least some examples, the UE can be configured to receive (e.g., obtain) a set of beams according to a plurality of beam groups, where a signaling indicating a subset of beams that the UE is expected to receive is communicated via DCI signaling according to a same format as that of at least one of cell DTX, cell DRX, and/or CHO indication. When beam hopping is enabled, the UE can implicitly determine that signaling indicated as part of at least one of cell DTX, cell DRX, and/or CHO configuration is to be used for beam hopping. Several implementations are described below. According to a possible implementation, one or more elements or features from one or more of the described implementations may be combined.

In implementations, a set of beams comprises a plurality of beam groups, each beam group of the plurality of beam groups includes one or more beams. For instance, beam grouping can be performed for CSI-RS and/or SSB resources. In an example, one or more beams in a beam group correspond to a same NZP CSI-RS resource set, where grouping information of the beams can be included in the CSI-RS resource set configuration IE. In another example, a UE can be configured with multiple CSI-RS resource sets, where the plurality of beam groups corresponds to a plurality of CSI-RS resource sets. In another example, one or more beams in a beam group can correspond to a plurality of SSB resources.

In implementations, each beam group can be associated with an information block of a DCI. An information block, for example, is a concatenation of bits of a given format, and the DCI may include one or more information blocks corresponding to one or more cells, beams, or a combination thereof. For instance, a UE can be configured with receiving a PDCCH corresponding to DCI Format 2_9 including N information blocks. Further, the UE can be configured with beam hopping for NTN (e.g., beam hopping can be indicated to UE in SIB 19 and/or as described above), where each information block of the N information blocks can correspond to a distinct beam group of the plurality of beam groups. In an example, an information block ID can correspond to a CSI-RS resource ID and/or an SSB resource ID. In another example, the information block ID can correspond to a CSI-RS resource set ID. In some examples, a new RNTI (e.g., configured by higher layer) associated with at least one of NTN, beam management, and/or beam hopping can be supported for scrambling of the DCI. Further, the new RNTI can differentiate between conventional use cases of DCI format 2_9 for cell DTX, cell DRX, and/or CHO, and use cases associated with beam management and/or beam hopping for NTN. In other examples, a new RRC indication signal can identify a DCI format 2_9 associated with beam management and/or beam hopping for NTN.

In implementations, a UE can be associated with multiple information blocks. The UE, for instance, is associated with one or more information blocks in the N information blocks, where N≥1 is a positive integer value. In an example, at least one indicator of a pointer to an index of an information block in the at least one information block is higher-layer configured via a higher-layer parameter, e.g., positionInDCI-cellDTRX. In another example, a DCI is common for a plurality of UEs, where each UE in the plurality of UEs is associated with a subset of the N information blocks. In another example, each information block of the N information blocks includes a bit corresponding to at least one of activating and deactivating beam hopping, where a presence of the bit in each information block can be based on a higher layer configuration parameter that configures the UE with beam hopping.

In implementations, beam hopping can be mapped to a CHO bit. For instance, only CHO can be configured to be enabled in each information block configured with NTN beam hopping, and bits associated with cell DTX and cell DRX are not configured. In one example, a higher-layer parameter corresponding to network energy savings (NES)-specific CHO (e.g., nesEvent) can be configured, and one or more higher-layer parameters corresponding to cell DTX and cell DRX (e.g., cellDTXDRXconfigType) are not configured.

In implementations DL and/or UL beam hopping can be mapped to respective cell DTX and/or DRX bits. For instance, at least one of cell DTX or cell DRX can be configured to be enabled in each information block when NTN beam hopping is enabled, whereas a bit associated with NES specific CHO configuration may not be configured. In an example, one or more higher-layer parameters corresponding to cell DTX and cell DRX (e.g., cellDTXDRXconfigType) are configured, and a higher-layer parameter corresponding to NES-specific CHO (e.g., nesEvent) is not configured. In another example, a higher-layer parameter corresponding to cell DTX is configured (e.g., a most significant bit (MSB) of cellDTXDRXconfigType parameter is equal to one), and a higher-layer parameter corresponding to cell DRX is not configured, e.g., a least significant bit (LSB) of cellDTXDRXconfigType parameter is equal to zero. In such scenarios, the UE can be expected to receive one or more DL beams corresponding to one or more NZP CSI-RS resources during active periods of the cell DTX, and may not be expected to receive the one or more DL beams during non-active periods of the cell DTX. In a further example, a higher-layer parameter corresponding to cell DRX is configured (e.g., an LSB of cellDTXDRXconfigType parameter is equal to one), whereas a higher-layer parameter corresponding to cell DTX is not configured, e.g., an MSB of cellDTXDRXconfigType parameter is equal to zero. In such scenarios, the UE can be expected to transmit one or more UL beams corresponding to one or more SRS resources during active periods of the cell DRX, and may not be expected to transmit the one or more UL beams during non-active periods of the cell DRX.

In implementations, beam hopping definitions can be provided in DL. For instance, a UE can be configured with beam hopping for DL and can be further configured with cell DTX that the UE is expected to receive SSB CSI-RS in cell DTX active periods, and may not be expected to receive CSI-RS in cell DTX non-active periods. In implementations, beam hopping definitions can be provided in UL. For instance, a UE can be configured with beam hopping for UL and can be further configured with cell DRX that the UE is expected to transmit SRS in cell DRX active periods, and may not be expected to transmit SRS in cell DRX non-active periods.

Implementations also provide alternative behaviors for tracking cell DTX/DRX active periods across UEs. For instance, when a UE is configured with beam hopping for DL and/or UL, the UE can be expected to be configured with monitoring a subset of active periods of cell DTX, configured with transmission over a subset of active periods of cell DRX, or a combination thereof. In an example, the UE can be configured with at least one of monitoring and transmission over alternating active periods of cell DTX, or active periods cell DRX, respectively. In another example, the UE can be configured with at least one of monitoring and transmission over every k^{th} active period of cell DTX and/or every k^{th} active period of cell DRX, respectively, where k is a positive integer value with at least a value of 2, and where the value of k can be based on a number of configured beam groups.

Implementations can also provide for cell to beam/beam group correspondence. For instance, when beam hopping is enabled and one or more of cell DTX, cell DRX, or CHO configuration are used to describe the parameters for beam hopping, the UE may implicitly imply that only one beam is associated with a cell. For instance, one SSB or beam-ID can be associated with PCI and may correspond to an be implicitly used by the UE for reporting purposes. In another example, the UE may implicitly imply that each beam group is associated with a distinct cell. Implementations can be utilized for both TN and NTN cells. For instance, when beam hopping is enabled and a UE is configured with cell DTX or cell DRX parameters, the UE may implicitly use these parameters for earth-fixed cells, quasi earth-fixed cells, and/or earth moving cells, e.g., if the cell layout is not separately configured.

Implementations also provide for CSI reporting for DL beam indication in NTN deployments. For instance, a UE can be configured with at least one CSI reporting setting when beam hopping is used, where a UE can transmit one or more CSI reports according to a configuration signaling corresponding to cell DTX and/or CHO signaling. Several implementations are described below and according to possible implementations, one or more elements or features from one or more of the described implementations may be combined.

In implementations, CSI reports can be transmitted based on receiving hopped beams. For instance, a first CSI report transmitted after an activation period of a cell DTX indication or a configured period of time following a reception of the PDCCH signal based on the DCI format, can be based on RSs corresponding to a beam group of the plurality of beam groups received over an active period of cell DTX. In an example, a UE can transmit a CSI report only if a beam group associated with the UE is transmitted over an active period of cell DTX, where at least one of the end of the active period of cell DTX or the end of transmission of the beams precedes a CSI reference resource associated with the CSI report setting. In another example, a UE may not be expected to transmit a periodic or semi-persistent CSI report if a beam group associated with the UE is not transmitted over an active period of cell DTX before the CSI reference resource associated with the CSI report setting. In another example, a UE that is configured with a subset of beam groups of the plurality of beam groups may not be expected to transmit a CRI in a CSI report that is configured for transmission in a first PUSCH, PUCCH resource dedicated for CSI reporting following the activation period that contains a CRI, L1-RSRP or L1-SINR associated with any beam that does not belong to the subset of beam groups. In implementations, a UE that is not configured with a beam group of a plurality of beam groups may not be expected to transmit a CSI report that is configured for transmission in a first PUSCH, PUCCH resource dedicated for CSI reporting following the activation period.

In implementations, a UE can be configured with a plurality of CSI report settings, and each CSI report setting in the plurality of CSI report settings can be associated with a beam group in a plurality of beam groups. In an example, each CSI report setting in the plurality of CSI report settings is associated with a same report quantity, e.g., RI, PMI, CQI, etc. In another example, a UE configured with beam hopping can be further configured with cell DTX, and the UE is expected to be a configured with a CSI report setting corresponding to a report quantity including at least one of ‘CRI’, SS/PBCH Block Resource Indicator (‘SSBRI’), ‘L1-RSRP’, ‘L1-SINR’ or ‘none’. In another example, each CSI report setting in the plurality of CSI report settings is associated with a report quantity with a value other than ‘none.’ In another example, a UE can report a single CSI report corresponding to the plurality of CSI report settings, where the single CSI report corresponds to a CSI report setting in the plurality of CSI report settings associated with a beam group, and the beam group can be activated as part of an information block of a DCI format associated with cell DTX.

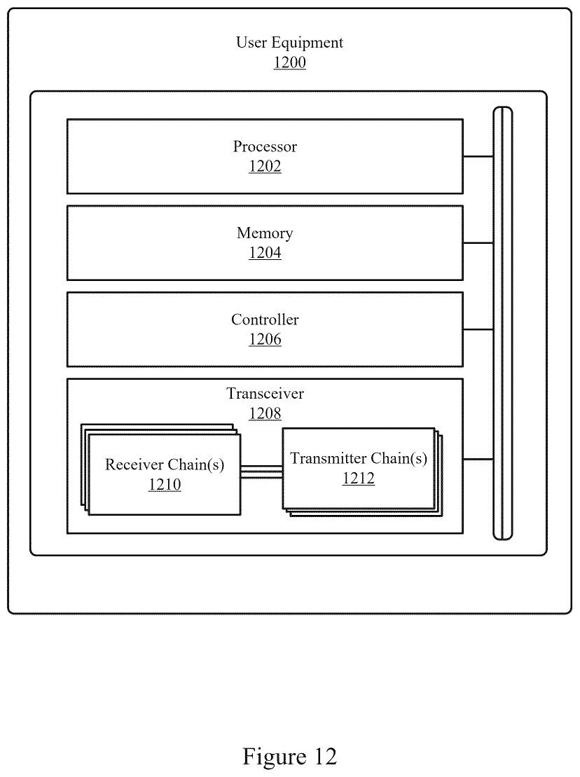

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving a set of beams including a plurality of subsets of beams; receiving an indication of an activation or deactivation of a first subset of beams of the plurality of subsets of beams; and monitoring the first subset of beams based at least in part on the indication.

Additionally, the UE 1200 may be configured to support any one or combination of wherein the set of beams is associated with a beam hopping framework, and the indication is received via a DCI; wherein the indication is received via a DCI, and the DCI corresponds to a DCI format associated with one or more of a cell DTX, cell DRX, or a CHO; wherein the indication is received via a DCI, the DCI includes a plurality of information blocks, and each information block of the plurality of information blocks corresponds to a respective subset of beams of the plurality of subsets of beams; further including receiving a higher-layer signal that identifies a location corresponding to a first bit of one or more information blocks of the plurality of information blocks included in the DCI that the UE is to monitor; wherein each information block of the plurality of information blocks identifies whether beams in the first subset of beams are activated or deactivated; wherein each beam in the set of beams corresponds to at least one of a NZP CSI-RS or a SSB.

Additionally, the UE 1200 may be configured to support any one or combination of wherein the at least one processor is configured to cause the UE to receive the at least one of the NZP CSI-RS or the SSB based at least in part on a cell DTX pattern, the cell DTX pattern includes alternating sequences of active slots and inactive slots, the active slots correspond to time slots in which the UE monitors for a reception of the at least one of the NZP CSI-RS or the SSB, and the inactive slots correspond to time slots in which the UE skips monitoring for the at least one of the NZP CSI-RS or SSB; wherein a quantity of inactive slots associated with a first beam in the first subset of beams includes a period of active slots associated with a second beam in a second subset of beams; wherein the first subset of beams and the second subset of beams are disjoint; further including transmitting a set of beams to a network entity, wherein each beam in the set of beams corresponds to a SRS transmitted by the UE; wherein the SRS is transmitted based at least in part on a cell DRX pattern, the cell DRX pattern includes alternating sequences of active slots and inactive slots, the active slots correspond to time slots in which the UE transmits the SRS, and the inactive slots correspond to time slots in which the UE suspends transmitting the SRS. In implementations, the inactive slots correspond to time slots in which the UE skips (e.g., suspends, refrains from, and/or stops) monitoring for the at least one of the NZP CSI-RS or SSB

Additionally, the UE 1200 may be configured to support any one or combination of wherein the indication is received via a DCI, and wherein the method further includes transmitting a CSI report or skipping transmitting the CSI report based at least in part on information in the DCI; further including transmitting the CSI report in response to receiving the indication within a threshold duration, wherein the indication identifies the activation of the first subset of beams in an information block; wherein the set of beams is associated with a beam hopping framework that corresponds to the UE receiving the first subset of beams from the set of beams at a first time duration, and the UE receiving a second subset of beams from the set of beams at a second time duration, and wherein the first time duration and the second time duration are non-overlapping. In implementations, skipping transmitting the CSI report based at least in part on information in the DCI can include suspending, stopping, and/or refraining from transmitting the CSI report.

Additionally, or alternatively, the UE 1200 may support at least one memory (e.g., the memory 1204) and at least one processor (e.g., the processor 1202) coupled with the at least one memory and configured to cause the UE to receive a set of beams including a plurality of subsets of beams; receive an indication of an activation or deactivation of a first subset of beams of the plurality of subsets of beams; and monitor the first subset of beams based at least in part on the indication.

Additionally, the UE 1200 may be configured to support any one or combination of wherein the set of beams is associated with a beam hopping framework, and the indication is received via a DCI; the indication is received via a DCI, and the DCI corresponds to a DCI format associated with one or more of a cell DTX, cell DRX, or a CHO; the indication is received via a DCI, the DCI includes a plurality of information blocks, and each information block of the plurality of information blocks corresponds to a respective subset of beams of the plurality of subsets of beams; the at least one processor is configured to cause the UE to receive a higher-layer signal that identifies a location corresponding to a first bit of one or more information blocks of the plurality of information blocks included in the DCI that the UE is to monitor; each information block of the plurality of information blocks identifies whether beams in the first subset of beams are activated or deactivated; each beam in the set of beams corresponds to at least one of a NZP CSI-RS or a SSB.

Additionally, the UE 1200 may be configured to support any one or combination of wherein the at least one processor is configured to cause the UE to receive the at least one of the NZP CSI-RS or the SSB based at least in part on a cell DTX pattern, the cell DTX pattern includes alternating sequences of active slots and inactive slots, the active slots correspond to time slots in which the UE monitors for a reception of the at least one of the NZP CSI-RS or the SSB, and the inactive slots correspond to time slots in which the UE skips monitoring for the at least one of the NZP CSI-RS or SSB; a quantity of inactive slots associated with a first beam in the first subset of beams includes a period of active slots associated with a second beam in a second subset of beams; the first subset of beams and the second subset of beams are disjoint; the at least one processor is configured to cause the UE to further transmit a set of beams to a network entity, wherein each beam in the set of beams corresponds to a SRS transmitted by the UE; the SRS is transmitted based at least in part on a cell DRX pattern, the cell DRX pattern includes alternating sequences of active slots and inactive slots, the active slots correspond to time slots in which the UE transmits the SRS, and the inactive slots correspond to time slots in which the UE suspends transmitting the SRS.

Additionally, the UE 1200 may be configured to support any one or combination of wherein the indication is received via a DCI, and wherein the at least one processor is configured to cause the UE to transmit a CSI report or skips (e.g., suspends, stops, refrains from) transmitting the CSI report based at least in part on information in the DCI; the at least one processor is configured to cause the UE to transmit the CSI report in response to receiving the indication within a threshold duration, wherein the indication identifies the activation of the first subset of beams in an information block; the set of beams is associated with a beam hopping framework that corresponds to the UE receiving the first subset of beams from the set of beams at a first time duration, and the UE receiving a second subset of beams from the set of beams at a second time duration, and wherein the first time duration and the second time duration are non-overlapping.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QCL). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

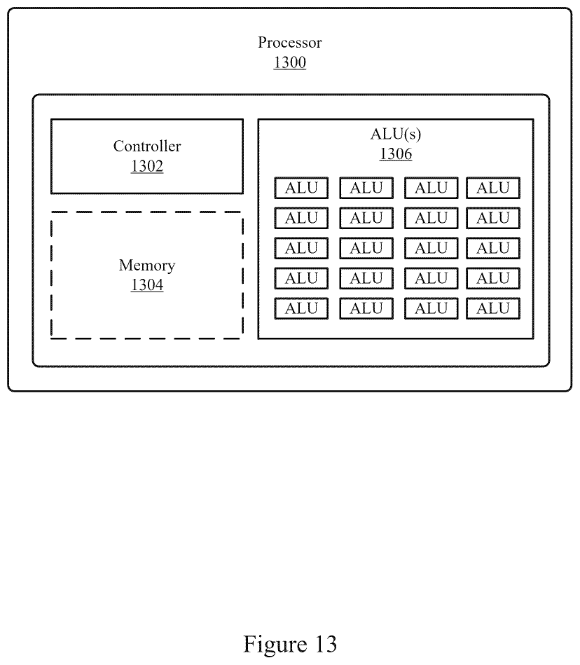

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive a set of beams including a plurality of subsets of beams; receive an indication of an activation or deactivation of a first subset of beams of the plurality of subsets of beams; and monitor the first subset of beams based at least in part on the indication.

Additionally, the processor 1300 may be configured to or operable to support any one or combination of where the set of beams is associated with a beam hopping framework, and the indication is received via a DCI; the indication is received via a DCI, and the DCI corresponds to a DCI format associated with one or more of a cell DTX, cell DRX, or a CHO; the indication is received via a DCI, the DCI includes a plurality of information blocks, and each information block of the plurality of information blocks corresponds to a respective subset of beams of the plurality of subsets of beams; the at least one controller is configured to cause the processor to receive a higher-layer signal that identifies a location corresponding to a first bit of one or more information blocks of the plurality of information blocks included in the DCI that the processor is to monitor; each information block of the plurality of information blocks identifies whether beams in the first subset of beams are activated or deactivated; each beam in the set of beams corresponds to at least one of a NZP CSI-RS or a SSB received at the processor.

Additionally, the processor 1300 may be configured to or operable to support any one or combination of where the at least one processor is configured to cause the UE to receive the at least one of the NZP CSI-RS or the SSB based at least in part on a cell DTX pattern, the cell DTX pattern includes alternating sequences of active slots and inactive slots, the active slots correspond to time slots in which the processor is to monitor a reception of the at least one of the NZP CSI-RS or the SSB, and the inactive slots correspond to time slots in which the processor skips monitoring for the reception of the at least one of the NZP CSI-RS or SSB; a quantity of inactive slots associated with a first beam in the first subset of beams includes a period of active slots associated with a second beam in a second subset of beams; the first subset of beams and the second subset of beams are disjoint; the at least one controller is configured to cause the processor to further transmit a set of beams to a network entity, wherein each beam in the set of beams corresponds to a SRS transmitted by the processor; the SRS is transmitted based at least in part on a cell DRX pattern, the cell DRX pattern includes alternating sequences of active slots and inactive slots, the active slots correspond to time slots in which the processor is to transmit the SRS, and the inactive slots correspond to time slots in which the processor is not to transmit the SRS. In implementations, disjoint sets/subsets (e.g., first subset of beams and the second subset of beam) include no common elements, e.g., no common beams.

Additionally, the processor 1300 may be configured to or operable to support any one or combination of where the indication is received via a DCI, and wherein the at least one controller is configured to cause the processor to transmit a CSI report or skips transmitting the CSI report based at least in part on information in the DCI; the at least one controller is configured to cause the processor to transmit the CSI report in response to receiving the indication within a threshold duration, wherein the indication identifies the activation of the first subset of beams in an information block; the set of beams is associated with a beam hopping framework that corresponds to the processor receiving the first subset of beams from the set of beams at a first time duration, and the processor receiving a second subset of beams from the set of beams at a second time duration, and wherein the first time duration and the second time duration are non-overlapping.

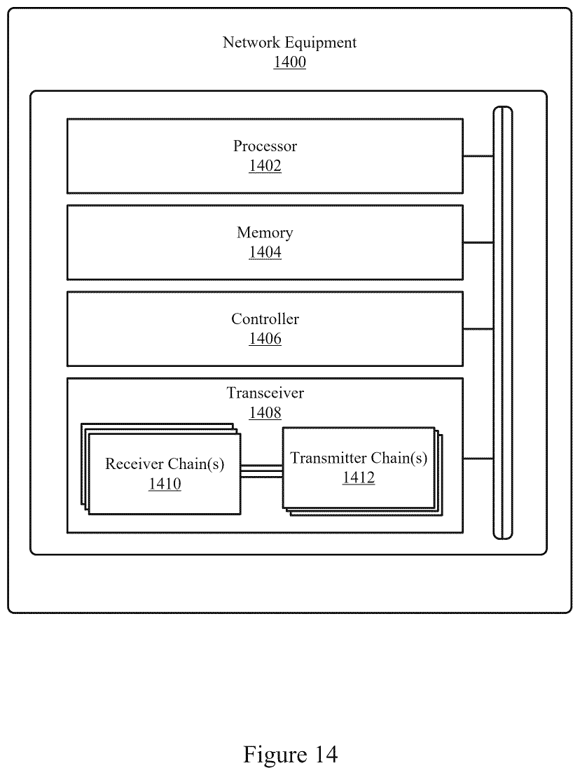

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting a set of beams including a plurality of subsets of beams; and transmitting an indication of an activation or deactivation of a first subset of beams of the plurality of subsets of beams.

Additionally, the NE 1400 may be configured to or operable to support any one or combination of where the set of beams is associated with a beam hopping framework, and the indication is transmitted via a DCI; the indication is transmitted via a DCI, and wherein a format of the DCI corresponds to a DCI format associated with one or more of a cell DTX, cell DRX, or a CHO.

Additionally, or alternatively, the NE 1400 may support at least one memory (e.g., the memory 1404) and at least one processor (e.g., the processor 1402) coupled with the at least one memory and configured to cause the NE to transmit a set of beams including a plurality of subsets of beams; and transmit an indication of an activation or deactivation of a first subset of beams of the plurality of subsets of beams.

Additionally, the NE 1400 may be configured to support any one or combination of wherein the set of beams is associated with a beam hopping framework, and the indication is transmitted via a DCI; wherein the indication is transmitted via a DCI, and wherein a format of the DCI corresponds to a DCI format associated with one or more of a cell DTX, cell DRX, or a CHO.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

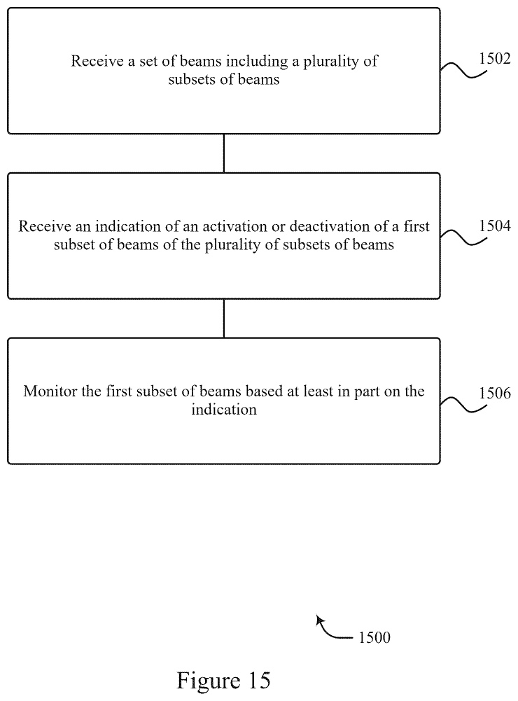

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving a set of beams including a plurality of subsets of beams. The operations of 1502 may be performed in accordance with examples as described herein. In some implementations, aspects of the operations of 1502 may be performed by a UE as described with reference to FIG. 12.

At 1504, the method may include receiving an indication of an activation or deactivation of a first subset of beams of the plurality of subsets of beams. The operations of 1504 may be performed in accordance with examples as described herein. In some implementations, aspects of the operations of 1504 may be performed by a UE as described with reference to FIG. 12.

At 1506, the method may include monitoring the first subset of beams based at least in part on the indication. The operations of 1506 may be performed in accordance with examples as described herein. In some implementations, aspects of the operations of 1506 may be performed a UE as described with reference to FIG. 12.

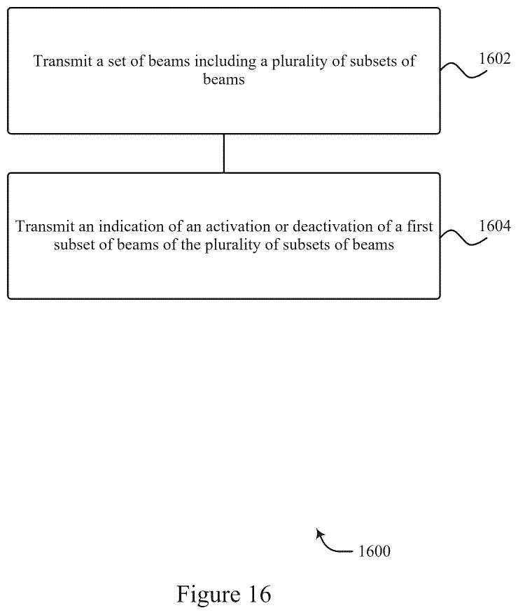

FIG. 16 illustrates a flowchart of a method 1600 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting a set of beams including a plurality of subsets of beams. The operations of 1602 may be performed in accordance with examples as described herein. In some implementations, aspects of the operations of 1602 may be performed by a NE as described with reference to FIG. 14.

At 1604, the method may include transmitting an indication of an activation or deactivation of a first subset of beams of the plurality of subsets of beams. The operations of 1604 may be performed in accordance with examples as described herein. In some implementations, aspects of the operations of 1604 may be performed by a NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a set of beams comprising a plurality of subsets of beams;
receive an indication of an activation or deactivation of a first subset of beams of the plurality of subsets of beams; and
monitor the first subset of beams based at least in part on the indication.

2. The UE of claim 1, wherein the set of beams is associated with a beam hopping framework, and the indication is received via a downlink control information (DCI).

3. The UE of claim 1, wherein the indication is received via a downlink control information (DCI), and the DCI corresponds to a DCI format associated with one or more of a cell discontinuous transmission (DTX), cell discontinuous reception (DRX), or a conditional handover (CHO).

4. The UE of claim 1, wherein the indication is received via a downlink control information (DCI), the DCI comprises a plurality of information blocks, and each information block of the plurality of information blocks corresponds to a respective subset of beams of the plurality of subsets of beams.

5. The UE of claim 4, wherein the at least one processor is configured to cause the UE to receive a higher-layer signal that identifies a location corresponding to a first bit of one or more information blocks of the plurality of information blocks of the DCI that the UE is to monitor.

6. The UE of claim 4, wherein each information block of the plurality of information blocks identifies whether beams in the first subset of beams are activated or deactivated.

7. The UE of claim 1, wherein each beam in the set of beams corresponds to at least one of a non-zero power (NZP) channel state information reference signal (CSI-RS) or a synchronization signal block (SSB).

8. The UE of claim 7, wherein the at least one processor is configured to cause the UE to receive the at least one of the NZP CSI-RS or the SSB based at least in part on a cell discontinuous transmission (DTX) pattern, the cell DTX pattern comprises alternating sequences of active slots and inactive slots, the active slots correspond to time slots in which the UE monitors for a reception of the at least one of the NZP CSI-RS or the SSB, and the inactive slots correspond to time slots in which the UE skips monitoring for the at least one of the NZP CSI-RS or SSB.

9. The UE of claim 8, wherein a quantity of inactive slots associated with a first beam in the first subset of beams comprises a quantity of active slots associated with a second beam in a second subset of beams.

10. The UE of claim 9, wherein the first subset of beams and the second subset of beams are disjoint.

11. The UE of claim 1, wherein the at least one processor is configured to cause the UE to further transmit a set of beams to a network entity, wherein each beam in the set of beams corresponds to a sounding reference signal (SRS) transmitted by the UE.

12. The UE of claim 11, wherein the SRS is transmitted based at least in part on a cell discontinuous reception (DRX) pattern, the cell DRX pattern comprises alternating sequences of active slots and inactive slots, the active slots correspond to time slots in which the UE transmits the SRS, and the inactive slots correspond to time slots in which the UE suspends transmitting the SRS.

13. The UE of claim 1, wherein the indication is received via a downlink control information (DCI), and wherein the at least one processor is configured to cause the UE to transmit a channel state information (CSI) report or skips transmitting the CSI report based at least in part on information in the DCI.

14. The UE of claim 13, wherein the at least one processor is configured to cause the UE to transmit the CSI report in response to receiving the indication within a threshold duration, wherein the indication identifies the activation of the first subset of beams in an information block.

15. The UE of claim 1, wherein the set of beams is associated with a beam hopping framework that corresponds to the UE receiving the first subset of beams from the set of beams at a first time duration, and the UE receiving a second subset of beams from the set of beams at a second time duration, and wherein the first time duration and the second time duration are non-overlapping.

16. A processor for wireless communication, comprising:
at least one controller coupled with at least one memory and configured to cause the processor to:
receive a set of beams comprising a plurality of subsets of beams;
receive an indication of an activation or deactivation of a first subset of beams of the plurality of subsets of beams; and
monitor the first subset of beams based at least in part on the indication.

17. A network equipment for wireless communication, comprising:
at least one memory; and
at least one processor coupled with the at least one memory and configured to cause the network equipment to:
transmit a set of beams comprising a plurality of subsets of beams; and
transmit an indication of an activation or deactivation of a first subset of beams of the plurality of subsets of beams.

18. The network equipment of claim 17, wherein the set of beams is associated with a beam hopping framework, and the indication is transmitted via a downlink control information (DCI).

19. The network equipment of claim 17, wherein the indication is transmitted via a downlink control information (DCI), and wherein a format of the DCI corresponds to a DCI format associated with one or more of a cell discontinuous transmission (DTX), cell discontinuous reception (DRX), or a conditional handover (CHO).

20. A method performed by a user equipment (UE), the method comprising:
receiving a set of beams comprising a plurality of subsets of beams;
receiving an indication of an activation or deactivation of a first subset of beams of the plurality of subsets of beams; and
monitoring the first subset of beams based at least in part on the indication.
